(19) United States
(12) Patent Application Publication
(10) Pub. No.: US 2026/0135094 A1
(43) Pub. Date: May 14, 2026

(54) Prelithiation Of Aluminum-Based Anodes For Solid-State Batteries

(71) Applicant: Georgia Tech Research Corporation, Atlanta, GA (US)

(72) Inventors: Matthew T. McDowell, Atlanta, GA (US); Congcheng Wang, Atlanta, GA (US); Yuhgene Liu, Atlanta, GA (US); Sazol Das, Atlanta, GA (US); Raj Gopalaswamy, Atlanta, GA (US); Diptarka Majumdar, Atlanta, GA (US)

(21) Appl. No.: 19/278,572

(22) Filed: Jul. 23, 2025

Related U.S. Application Data
(62) Division of application No. 18/948,049, filed on Nov. 14, 2024, now abandoned.

(51) Int. Cl. H01M 4/46; H01M 4/02; H01M 4/04

(52) U.S. Cl. CPC H01M 4/463; H01M 4/0435; H01M 2004/021; H01M 2004/027

(57) ABSTRACT

A method including compressively rolling a first foil and a second foil together such that lithium in the second foil reacts with aluminum in the first foil, and converting aluminum or aluminum alloy in a first phase of the first foil to a lithium-aluminum alloy to form a prelithiated anode material, wherein the first foil comprises a first phase having aluminum or an aluminum alloy, wherein between 50-99 at % of a composite foil of the first foil and the second foil comprises the first phase, and a second phase interspersed with the first phase, the second phase has a conductive element, wherein between 1-50 at % of the composite foil comprises the second phase, and the second foil has lithium.

### CROSS-REFERENCE TO RELATED APPLICATIONS

This Application is a divisional of U.S. patent application Ser. No. 18/948,049 filed 14 Nov. 2024, the entire contents and substance of each are incorporated herein by reference in its entirety as if fully set forth below.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The various embodiments of the present disclosure relate generally to solid-state batteries and more particularly to solid-state batteries having prelithiated anodes and methods of making the same.

### 2. Description of Related Art

Solid-state batteries are an emerging technology that could be safer than conventional Li-ion batteries while also allowing for the use of new electrode materials that could increase the energy density and specific energy compared to Li-ion batteries. Solid-state batteries feature an active cathode material, a solid-state ion-conducting separator, and an active anode material. The cathode and anode materials store lithium ions, which travel back and forth between the two during charge and discharge.

Research on solid-state batteries largely focuses on either pure lithium metal anodes or composite anodes that contain active materials mixed with inactive solid-state ion-conducting material. Lithium metal is a promising anode material, but it poses substantial challenges due to the formation of lithium dendrites, which cause short circuiting and battery failure. Composite anodes that contain inactive solid electrolyte feature low energy density because of the excess of inactive material. PCT Publication No. WO/2024186888, entitled “Solid-State Batteries with Aluminum-Based Composite Foil Anodes Exhibiting Multiphase Microstructure,” which incorporated herein by reference in its entirety as if fully set forth below, is by the same inventors and details the use of aluminum foil-based anodes in solid-state batteries for improved energy storage capabilities. This includes designs for multiphase alloy foil anodes that feature significantly improved performance, including methodologies to enable improved performance at low stack pressure. However, there is still a need for improved solid-state batteries with improved energy storage performance. The present disclosure provides such batteries.

### SUMMARY OF THE DISCLOSURE

An exemplary embodiment of the present disclosure provides a solid-state battery, comprising a prelithiated composite foil anode, a cathode, and a solid-state electrolyte between the anode and the cathode. The anode can comprise a first metal phase and a second metal phase. The first metal phase can comprise an aluminum-lithium alloy. About 50-99% at % of the anode can consist of the first metal phase. The second metal phase can be interspersed with the first metal phase. The second metal phase can comprise a conductive element having a redox potential for alloying with lithium that is greater than or equal to the lithium alloying potential of aluminum (0.33 V vs. Li/Li⁺). The second metal phase of the foils can comprise a conductive element having a redox potential for alloying with lithium that is less than redox potential for lithium alloying with aluminum. 1-50% at % of the anode can consist of the second metal phase.

In any of the embodiments disclosed herein, the anode can further comprise a third metal phase.

In any of the embodiments disclosed herein, the conductive element can be silicon, tin, indium, carbon, gallium, antimony, lead, nickel, copper, germanium, zinc, bismuth, magnesium, manganese, silver, or any combination thereof.

In any of the embodiments disclosed herein, the conductive element can comprise indium.

In any of the embodiments disclosed herein, the second metal phase can comprise lithium-indium.

In any of the embodiments disclosed herein, the second metal phase can be present as a plurality of individual domains within the first metal phase.

In any of the embodiments disclosed herein, at least some of the plurality of individual domains can exhibit a cross-sectional dimension of less than 10 microns.

In any of the embodiments disclosed herein, the second metal phase can comprise a lithiated form of the conductive element.

In any of the embodiments disclosed herein, 80-98% at % of the anode can consist of the first metal phase.

In any of the embodiments disclosed herein, the solid-state battery can exhibit an initial Coulombic efficiency of >80% and an average Coulombic efficiency above 99.5% for over 100 cycles.

In any of the embodiments disclosed herein, the solid-state battery can exhibit an areal capacity of >2 mAh cm⁻² for over 100 cycles.

Another exemplary embodiment of the present disclosure provides a method comprising compressively rolling a first foil and a second foil together such that lithium in the second foil reacts with aluminum in the first foil, and converting aluminum or aluminum alloy in a first phase of the first foil to a lithium-aluminum alloy to form a prelithiated anode material, wherein the first foil comprises a first phase comprising aluminum or an aluminum alloy, wherein between 50-99 at % of a composite foil of the first foil and the second foil comprises the first phase, and a second phase interspersed with the first phase, the second phase comprising a conductive element, wherein between 1-50 at % of the composite foil comprises the second phase, and the second foil comprises lithium.

In any of the embodiments disclosed herein, the prelithiated anode material can further comprise pristine aluminum comprising <5 at % lithium.

In any of the embodiments disclosed herein, the prelithiated anode material can further comprise pristine indium comprising <5 at % lithium.

In any of the embodiments disclosed herein, the prelithiated anode material can further comprise pristine bismuth comprising <5 at % lithium.

In any of the embodiments disclosed herein, the method can further comprise providing a cathode, and positioning a solid-state electrolyte between the prelithiated anode material and the cathode, wherein the method forms a solid-state battery.

In any of the embodiments disclosed herein, between 80-98 at % of the first foil can comprise the first phase.

In any of the embodiments disclosed herein, the second foil can comprise a foil that is inert to reaction with lithium and the lithium forms a layer on the second foil that is inert to reaction with lithium.

In any of the embodiments disclosed herein, the compressively rolling can occur at a temperature of between 20-150° C.

In any of the embodiments disclosed herein, the first phase of the first foil can comprise a lithium-aluminum alloy, wherein between 45-99 at % of the first phase comprises lithium.

In any of the embodiments disclosed herein, the second phase of the first foil can comprise an alloy selected from a group consisting of a lithium-indium alloy and lithium-bismuth alloy interspersed with the first foil phase, wherein between 45-99 at % of the second phase comprises lithium.

In any of the embodiments disclosed herein, the lithium-aluminum alloy can have a lithium-to-aluminum ratio of approximately 11.

In any of the embodiments disclosed herein, the solid-state battery can exhibit an initial Coulombic efficiency of >80% and an average Coulombic efficiency above 99.5% for over 100 cycles.

In any of the embodiments disclosed herein, the solid-state battery can exhibit an areal capacity of >2 mAh cm⁻² for over 100 cycles.

In any of the embodiments disclosed herein, the lithium layer can have a thickness of between 0.1-50 microns.

In any of the embodiments disclosed herein, the method further comprises depositing the lithium on the second foil that is inert to reaction with lithium.

In any of the embodiments disclosed herein, the depositing can comprise depositing using electrodeposition, thermal evaporation, rolling a lithium foil with the foil that is inert to reaction with lithium, or combinations thereof.

Another exemplary embodiment of the present disclosure provides a method of a method of making a solid-state battery comprising forming a prelithiated composite foil anode comprising compressively rolling a first foil and a second foil of the prelithiated composite foil anode together such that lithium in the second foil reacts with aluminum in the first foil, wherein the first foil comprises a first foil phase comprising a lithium-aluminum alloy, wherein between 45-99 at % of the first foil phase comprises lithium, and a second foil phase comprising an alloy selected from a group consisting of a lithium-indium alloy and lithium-bismuth alloy interspersed with the first foil phase, wherein between 45-99 at % of the second foil phase comprises lithium, and wherein the second foil comprises lithium, providing a cathode, and positioning a solid-state electrolyte between the anode and the cathode.

In any of the embodiments disclosed herein, between 80-98 at % of the first foil can comprise the first foil phase.

In any of the embodiments disclosed herein, the second foil can comprise a foil that is inert to reaction with lithium and the lithium forms a layer on the foil that is inert to reaction with lithium.

In any of the embodiments disclosed herein, the compressively rolling can occur at a temperature of between 20-150° C.

In any of the embodiments disclosed herein, the prelithiated composite foil anode can further comprise pristine aluminum comprising <5 at % lithium, a pristine indium comprising <5 at % lithium, or pristine bismuth comprising <5 at % lithium.

In any of the embodiments disclosed herein, between 50-99 at % of the prelithiated composite foil anode can comprise the first foil phase, and between 1-50 at % of the prelithiated composite foil anode can comprise the second foil phase.

In any of the embodiments disclosed herein, the solid-state battery can exhibit an initial Coulombic efficiency of >80% and an average Coulombic efficiency above 99.5% for over 100 cycles.

In any of the embodiments disclosed herein, the solid-state battery can exhibit an areal capacity of >2 mAh cm⁻² for over 100 cycles.

In any of the embodiments disclosed herein, the lithium-aluminum alloy of the first phase can have a lithium-to-aluminum ratio of approximately 11.

In any of the embodiments disclosed herein, the lithium layer can have a thickness of between 0.1-50 microns.

In any of the embodiments disclosed herein, the forming the prelithiated composite foil anode can further comprise depositing the lithium on the foil that is inert to reaction with lithium, wherein the lithium layer has a thickness of between 0.1-50 microns.

Another exemplary embodiment of the present disclosure provides a solid-state battery comprising a prelithiated composite foil anode comprising a first metal phase comprising an aluminum-lithium alloy, wherein between 50-99 atomic percent (at %) of the anode comprises the first metal phase, and a second metal phase interspersed with the first metal phase, the second metal phase comprising a conductive element having a lithium alloying potential greater than or equal to a lithium alloying potential of aluminum, wherein between 1-50 at % of the anode comprises the second metal phase, a cathode, and a solid-state electrolyte between the anode and the cathode.

In any of the embodiments disclosed herein, the conductive element can be selected from a group consisting of silicon, tin, indium, carbon, gallium, antimony, lead, nickel, copper, germanium, zinc, bismuth, magnesium, manganese, silver, and any combination thereof.

In any of the embodiments disclosed herein, the conductive element can comprise indium.

In any of the embodiments disclosed herein, the second metal phase can comprise lithium-indium.

In any of the embodiments disclosed herein, the second metal phase can be present as a plurality of individual domains within the first metal phase.

In any of the embodiments disclosed herein, at least a portion of the individual domains can exhibit a cross-sectional dimension of less than 10 microns.

In any of the embodiments disclosed herein, the second metal phase can comprise a lithiated form of the conductive element.

In any of the embodiments disclosed herein, between 80-98 at % of the anode comprises the first metal phase.

In any of the embodiments disclosed herein, the solid-state battery can exhibit an initial Coulombic efficiency of >80% and an average Coulombic efficiency above 99.5% for over 100 cycles.

In any of the embodiments disclosed herein, the solid-state battery can exhibit an areal capacity of >2 mAh cm⁻² for over 100 cycles.

Another exemplary embodiment of the present disclosure provides an uncycled solid-state battery comprising a prelithiated composite foil anode comprising a first phase comprising a lithium-aluminum alloy, wherein between 50-99 atomic percent (at %) of the anode comprises the first phase, and a second metal phase interspersed with the first phase, the second metal phase comprising a conductive element having a lithium alloying potential greater than or equal to a lithium alloying potential of aluminum, wherein between 1-50 at % of the anode comprises the second metal phase, a cathode, and a solid-state electrolyte between the anode and the cathode.

1Another exemplary embodiment of the present disclosure provides a uncycled solid-state battery comprising a prelithiated composite foil anode comprising a first phase comprising a lithium-aluminum alloy, wherein between 45-99 atomic percent (at %) of the first phase comprises lithium, and a second metal phase comprising an alloy selected from a group consisting of a lithium-indium alloy and lithium-bismuth alloy interspersed with the first phase, wherein between 45-99 at % of the second metal phase comprises lithium, a cathode, and a solid-state electrolyte between the anode and the cathode.

Another embodiment of the present disclosure provides a method of making an anode for a solid-state battery. The method can comprise: providing a first foil, comprising: a first metal phase comprising aluminum or an aluminum alloy, wherein 50-99% at % of the composite foil consists of the first metal phase; and a second metal phase interspersed with the first metal phase, the second metal phase comprising a conductive element having a lithium alloying potential greater than or equal to a lithium alloying potential of aluminum, wherein 1-50% at % of the composite foil consists of the second metal phase; providing a second foil comprising lithium; and compressively rolling the first and second foils together such that the lithium in the second foil reacts with aluminum and other phase(s) in the first foil to convert the aluminum or aluminum alloy and/or other phases in the first metal phase to a lithiated alloy to form a prelithiated anode material.

In any of the embodiments disclosed herein, the second foil can comprise a copper foil or other foil that is inert to lithium reaction, and the lithium can form a layer on the copper foil or other foil that is inert to lithium reaction.

In any of the embodiments disclosed herein, the lithium layer can have a thickness of 0.1-50 microns.

In any of the embodiments disclosed herein, the method can further comprise depositing the lithium on the copper foil or other foil that is inert to lithium reaction.

In any of the embodiments disclosed herein, depositing the lithium on the copper foil or other foil that is inert to lithium reaction can be performed using electrodeposition, thermal evaporation, rolling a lithium foil with the copper foil, or combinations thereof.

In any of the embodiments disclosed herein, the method can further comprise: providing a cathode; and positioning a solid-state electrolyte material between the cathode and the prelithiated anode material to form a solid-state battery.

In any of the embodiments disclosed herein, compressively rolling the first and second foils together can occur at a temperature from 20-150° C.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a schematic illustration of a prelithiation method for alloy anodes by roll pressing, in accordance with some embodiments of the present disclosure.

FIG. 2 provides a photograph of a prelithiated foil electrode, in accordance with some embodiments of the present disclosure.

FIG. 3 provides a scanning electron microscope image with a scale of 100 μm showing cross-section of a prelithiated aluminum foil sample having a lithium alloy layer and an aluminum layer, in accordance with some embodiments of the present disclosure.

FIG. 4 provides a focused ion beam-scanning electron microscope image with a scale of 10 μm showing a cross-section of a prelithiated aluminum foil sample having a lithium-aluminum alloy layer and an aluminum layer, in accordance with some embodiments of the present disclosure.

FIG. 5 provides the X-ray diffraction characterization data of the exemplary prelithiated aluminum foil sample shown in FIG. 4 showing the lithium-aluminum phase and aluminum phase.

FIG. 6 provides hall-cell test data of the exemplary prelithiated aluminum foil electrode shown in FIG. 4, in which the prelithiated aluminum foil electrode is lithiated to 0.01 V vs Li/Li⁺, then delithiated to 1.0 V vs Li/Li⁺, and the current density used is 0.1 mA cm⁻².

FIG. 7 provides a focused ion beam-scanning electron microscope image with a scale of 5 μm showing cross-section of a prelithiated aluminum-bismuth foil sample having a lithium-aluminum alloy layer, an aluminum layer, and lithium-bismuth alloys distributed in the sample, in accordance with some embodiments of the present disclosure.

FIG. 8 provides the X-ray diffraction characterization data of the exemplary prelithiated aluminum-bismuth foil sample in FIG. 7 showing the lithium-aluminum phase, aluminum phase, lithium-bismuth phase, and bismuth phase.

FIG. 9 provides hall-cell test data of the exemplary prelithiated aluminum-bismuth foil electrode shown in FIG. 7, in which the prelithiated aluminum-bismuth foil electrode is lithiated to 0.01 V vs Li/Li⁺, then delithiated to 1.0 V vs Li/Li⁺, and the current density used is 0.1 mA cm⁻².

FIG. 10 provides a focused ion beam-scanning electron microscope image with a scale of 5 μm showing cross-section of a prelithiated aluminum-indium foil sample having a lithium-aluminum alloy layer, an aluminum layer, and a lithium-indium alloy network distributed in the sample, in accordance with some embodiments of the present disclosure.

FIG. 11 provides the X-ray diffraction characterization data of the prelithiated aluminum-indium foil sample shown in FIG. 10, showing the lithium-aluminum phase, aluminum phase, and lithium-indium phase.

FIG. 12 provides hall-cell test data of the prelithiated aluminum-indium foil electrode shown in FIG. 10, in which the prelithiated aluminum-indium foil electrode is lithiated to 0.01 V vs Li/Li⁺, then delithiated to 1.0 V vs Li/Li⁺, and the current density used is 0.1 mA cm⁻².

FIG. 13 provides the galvanostatic cycling data over 100 cycles of exemplary prelithiated aluminum foils, along with LiNi_{0.6}Co_{0.2}Mn_{0.2}O₂ cathode and Li₆PS₅Cl solid-state electrolyte, in which the stack pressure is 50 MPa, the temperature is 25° C., the cathode loading is 4 mAh cm⁻², and the current density is 0.2 mA cm⁻² for cycle 1-2 and 1 mA cm⁻² for the subsequent cycles.

FIG. 14 provides the galvanostatic voltage curves for the first, tenth, and one-hundredth cycles of the cycling test in FIG. 13.

FIG. 15 provides the galvanostatic cycling data over 100 cycles of a full cell featuring pristine (non-prelithiated) aluminum foil, along with LiNi_{0.6}Co_{0.2}Mn_{0.2}O₂ cathode and Li₆PS₅Cl solid-state electrolyte, in which the stack pressure is 50 MPa, the temperature is 25° C., the cathode loading is 5 mAh cm⁻², and the current density is 0.2 mA cm⁻² for cycle 1-2 and 1 mA cm⁻² for the subsequent cycles.

FIG. 16 provides the galvanostatic voltage curves on the first, tenth, and one-hundredth cycles of the cycling test in FIG. 15.

FIG. 17 provides the galvanostatic cycling data over 100 cycles of exemplary prelithiated aluminum-bismuth foils, along with LiNi_{0.6}Co_{0.2}Mn_{0.2}O₂ cathode and Li₆PS₅Cl solid-state electrolyte, in which the stack pressure is 50 MPa, the temperature is 25° C., the cathode loading is 4 mAh cm⁻², and the current density is 0.2 mA cm⁻² for cycle 1-2 and 1 mA cm⁻² for the subsequent cycles.

FIG. 18 provides the galvanostatic voltage curves on the first, tenth, and one-hundredth cycles of the cycling test in FIG. 17.

FIG. 19 provides the galvanostatic cycling data over 200 cycles of exemplary prelithiated aluminum-silicon foils, along with LiNi_{0.6}Co_{0.2}Mn_{0.2}O₂ cathode and Li₆PS₅Cl solid-state electrolyte, in which the stack pressure is 50 MPa, the temperature is 25° C., the cathode loading is 4 mAh cm⁻², and the current density is 0.2 mA cm⁻² for cycle 1-2 and 1 mA cm⁻² for the subsequent cycles.

FIG. 20 provides the galvanostatic voltage curves on the first, tenth, and one-hundredth cycles of the cycling test in FIG. 19.

FIG. 21 provides the galvanostatic cycling data over 500 cycles of exemplary prelithiated aluminum-indium foils, along with LiNi_{0.6}Co_{0.2}Mn_{0.2}O₂ cathode and Li₆PS₅Cl solid-state electrolyte, in which the stack pressure is 50 MPa, the temperature is 25° C., the cathode loading is 4 mAh cm⁻², and the current density is 0.2 mA cm⁻² for cycle 1-2 and 2 mA cm⁻² for the subsequent cycles.

FIG. 22 provides the galvanostatic voltage curves on the tenth, one-hundredth, and five-hundredth cycles of the cycling test in FIG. 21.

FIG. 23 provides the galvanostatic cycling data over 500 cycles of exemplary prelithiated aluminum-indium foils with indium interfacial layer, along with LiNi_{0.6}Co_{0.2}Mn_{0.2}O₂ cathode and Li₆PS₅Cl solid-state electrolyte, in which the stack pressure is 5 MPa, the temperature is 25° C. or 60° C., the cathode loading is 4 mAh cm⁻², and the current density is 0.2 mA cm⁻² for cycle 1-2 and 2 mA cm⁻² for the subsequent cycles.

FIG. 24 provides the galvanostatic voltage curves on the tenth, one-hundredth, and five-hundredth cycles of the cycling test in FIG. 23.

FIG. 25 provides the galvanostatic cycling data over 350 cycles of exemplary prelithiated aluminum-indium foils with indium interfacial layer, along with LiNi_{0.6}Co_{0.2}Mn_{0.2}O₂ cathode and Li₆PS₅Cl solid-state electrolyte, in which the stack pressure is 2 MPa, the temperature is 25° C., the cathode loading is 4 mAh cm⁻², and the current density is 0.2 mA cm⁻² for cycle 1-2 and 0.5 mA cm⁻² for the subsequent cycles.

FIG. 26 provides the galvanostatic voltage curves on the tenth, one-hundredth, and five-hundredth cycles of the cycling test in FIG. 25.

### DETAIL DESCRIPTION OF THE INVENTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

The present disclosure describes a methodology for prelithiation of aluminum-based foil anodes for solid-state batteries. These processes, which are described below, can be used with many different foil anode materials, including, but not limited to, pure Al foil, commercially available Al alloys, or multicomponent Al foil materials. Exemplary foils that can be utilized are disclosed in PCT Publication No. WO/2024186888, entitled “Solid-State Batteries with Aluminum-Based Composite Foil Anodes Exhibiting Multiphase Microstructure,” which incorporated herein by reference in its entirety as if fully set forth below. In some embodiments, the multicomponent foils can have two or more metal phases. For example, in some embodiments, a first metal phase can comprise aluminum or an aluminum alloy. In some embodiments, a second metal phase of the foils can comprise a conducting element, which can have a redox potential for alloying with lithium that is greater than or equal to the redox potential for lithium alloying with aluminum (0.33 V vs. Li/Li⁺). In some embodiments, a second metal phase of the foils can comprise a conducting element which can have a redox potential for alloying with lithium that is less than the redox potential for lithium alloying with aluminum (0.33 V vs. Li/Li⁺). In some embodiments, the conducting element in the second metal phase can be selected from the group, including, but not limited to, silicon, tin, indium, carbon, gallium, antimony, lead, nickel, copper, germanium, zinc, bismuth, magnesium, manganese, silver, the like, or any combination thereof. For example, in some embodiments, the second metal phase can comprise indium. Additionally, in some embodiments, the second metal phase can comprise a lithiated form of the conductive element, e.g., lithium-indium.

As disclosed in PCT Publication No. WO/2024186888, in some embodiments, the second metal phase can be interspersed with the first metal phase. For example, in some embodiments, the second metal phase can be present as a plurality of individual domains within the first metal phase to provide a multicomponent foil. In such embodiments, the plurality of individual domains can exhibit a cross-sectional dimension of less than 10 microns.

In embodiments where the foil comprises multiple metal phases, the foil can comprise varying amounts of each phase. For example, in some embodiments, at least 50 at % of the foil can consist of the first metal phase. In some embodiments, at least 60 at %, at least 70 at %, or at least 80 at % of the foil can consist of the first metal phase. The remaining portions of the foil can comprise the second (or other phases). For example, in some embodiments, about 50-99 at % of the foil can consist of the first metal phase and about 1-50 at % can consist of the second metal phase. In some embodiments, about 80-98 at % can consist of the first metal phase and 2-20 at % can consist of the second phase. The present disclosure, however, is not limited to two phase foils; rather, as those skilled in the art would appreciate, some embodiments, can include three or more phases.

An exemplary embodiment of the present disclosure provides a method of making an anode for a solid-state battery. The method can comprise providing a first foil, which can be any of the foils disclosed above. For example, the first foil can comprise a first metal phase comprising aluminum or an aluminum alloy. The method can further comprise providing second foil comprising lithium. The first and second foils can be provided in many forms, such as a rolled foil sheet. The method can further comprise compressively rolling the first and second foils together such that the lithium in the second foil reacts with aluminum in the first foil to convert the aluminum or aluminum alloy in the first metal phase to a lithium-aluminum alloy to form a prelithiated anode material.

In some embodiments, the second foil can comprise a first material, such as copper, having a layer of lithium thereon. The lithium layer can have many different thicknesses, e.g., from 0.1-50 microns. The thickness of the lithium layer can vary according to a desired level of lithiation for the prelithiated anode material, i.e., a thicker lithium layer can result in a higher degree of lithiation of the resulting anode material.

The lithium layer can be deposited on the first material (e.g., copper) in many different ways known in the art, including, but not limited to, electrodeposition, thermal evaporation, rolling a lithium foil with the copper foil, or combinations thereof.

Compressively rolling the first and second foils together can occur over a wide range of operating parameters, e.g., pressure, temperature, etc., in accordance with various embodiments of the present disclosure. For example, in some embodiments, compressively rolling the first and second foils together can occur at a temperature of 20-150° C.

In some embodiments, the method can further comprise providing a cathode and positioning a solid-state electrolyte material between the cathode and the prelithiated anode material to form a solid-state battery.

The use of the prelithiated anode foils disclosed herein in solid-state batteries provides for improved performance of such batteries over conventional devices. For example, in some embodiments, the solid-state battery exhibits an initial Coulombic efficiency of >80%, an average Coulombic efficiency above 99.5%, and an areal capacity of >2 mAh cm⁻² for over 100 cycles at stack pressures of 5 MPa. In some embodiments, the prelithiation improves the reversible capacity exhibited by the battery by 30-40%.

### EXAMPLES

Below certain exemplary embodiments of the present disclosure are described. These examples are provided for explanatory purposed only and should not be construed as limiting the scope of the present disclosure.

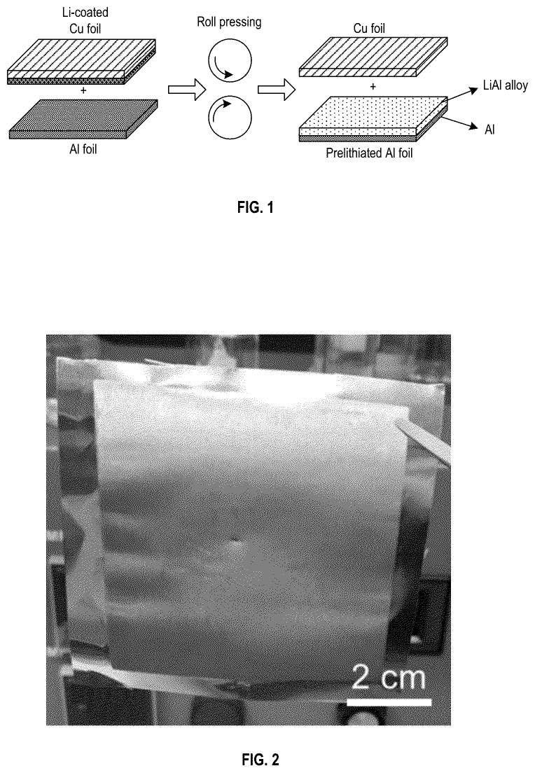

FIG. 1 shows a schematic of an exemplary roll-based prelithiation process. In this process, the Al-based foil is compressively rolled in contact with a Cu foil that features a controlled thickness of lithium metal on the surface. This thickness of lithium metal can vary from 0.1 micron to more than 50 microns, and can be deposited by electrodeposition, thermal evaporation, or cold rolling of separate foils. The thickness of the lithium layer can be determined by the desired extent of prelithiation. During rolling of the Al-based foil with the lithium-coated Cu foil, the lithium can spontaneously react with the Al-based foil and its constituent components to form Li—Al alloy phases and other alloy phases. FIG. 2 shows a photograph of a prelithiated Al foil anode fabricated by a roll-to-roll method.

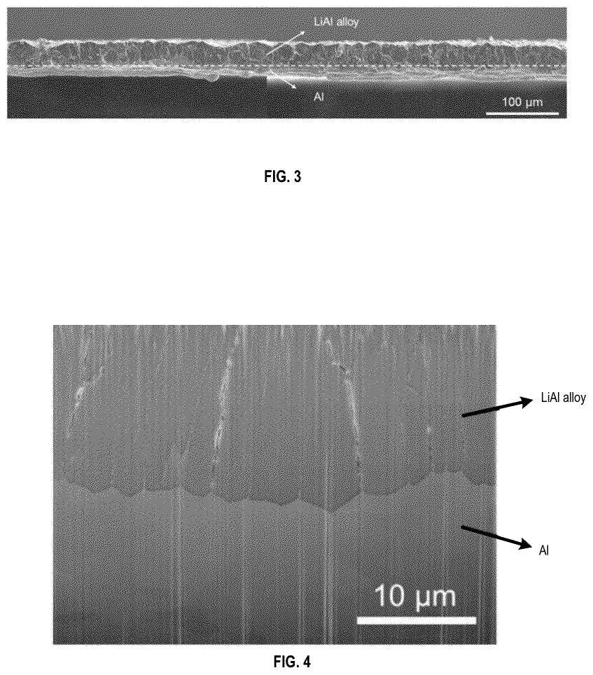

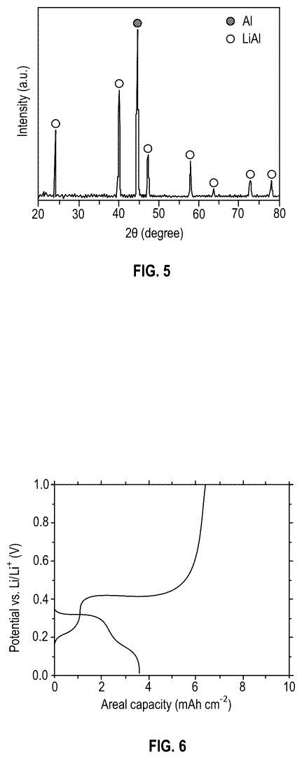

FIGS. 3-4 show cross-sectional scanning electron microscope (SEM) images of a prelithiated Al foil. The roll-to-roll reaction technique can provide uniform lithiation of Al foils. In the prelithiated electrode, the Li alloy layer can serve as active material and the pristine metal layer can work as a current collector. FIG. 5 provides X-ray diffraction (XRD) characterization result of the prelithiated Al foil, showing the two phases of LiAl alloy and pure Al in the sample. Proper prelithiation can help recover the lithium loss of alloy anodes in the first lithiation/delithiation cycle. FIG. 6 shows the hall-cell test data of the prelithiated Al foil electrode. With prelithiation, the sample displays an initial Coulombic efficiency (ICE) of 176.5% in the first cycle with an areal delithiation capacity of 6.47 mAh cm⁻², which is sufficient to meet the areal capacity of conventional lithium batteries.

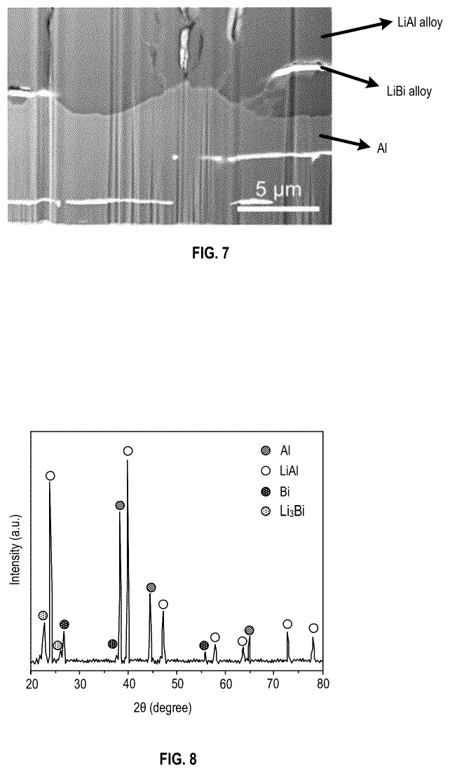

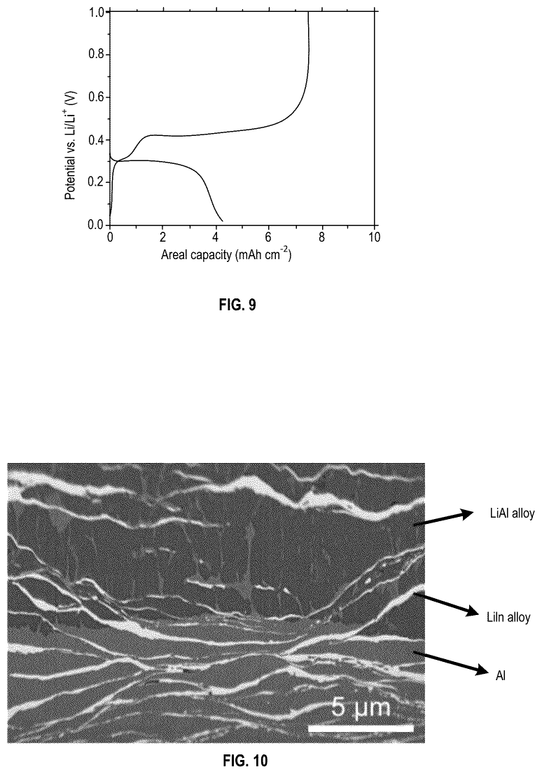

FIG. 7 shows cross-sectional SEM images of a prelithiated Al—Bi foil electrode. The prelithiated sample has two layers of LiAl alloy and pristine Al, with the second phase of Bi dispersed in the Al foil matrix. FIG. 8 provides XRD characterization result of the prelithiated Al—Bi foil, showing the four phases of LiAl alloy, pure Al, Li₃Bi alloy, and pure Bi in the sample. FIG. 9 shows the hall-cell test data of the prelithiated Al—Bi foil electrode. With prelithiation, the sample displays an initial Coulombic efficiency of 181.2% in the first cycle with an areal delithiation capacity of 7.58 mAh cm⁻².

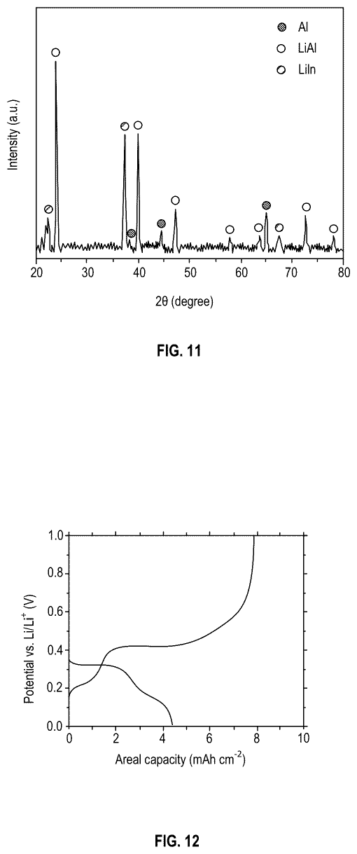

FIG. 10 shows cross-sectional SEM images of a prelithiated Al—In foil electrode. The prelithiated sample has two layers of LiAl alloy and pristine Al, with a 3D network of LiIn throughout the Al foil matrix, which enables the lithiation of all In in the foil to form LiIn. FIG. 11 provides XRD characterization result of the prelithiated Al—In foil, showing the three phases of LiAl alloy, pure Al, and LiIn alloy in the sample. FIG. 12 shows the hall-cell test data of the prelithiated Al—In foil electrode. With prelithiation, the sample displays a high initial Coulombic efficiency of 188.5% in the first cycle with an areal delithiation capacity of 7.95 mAh cm⁻².

These prelithiated alloy foils can then be assembled into solid-state batteries. The incorporation of Li directly within the foils before battery assembly can allow for an excess of Li to be present in the cell, which can be helpful for mitigating any loss of Li due to side reactions during charge/discharge cycling.

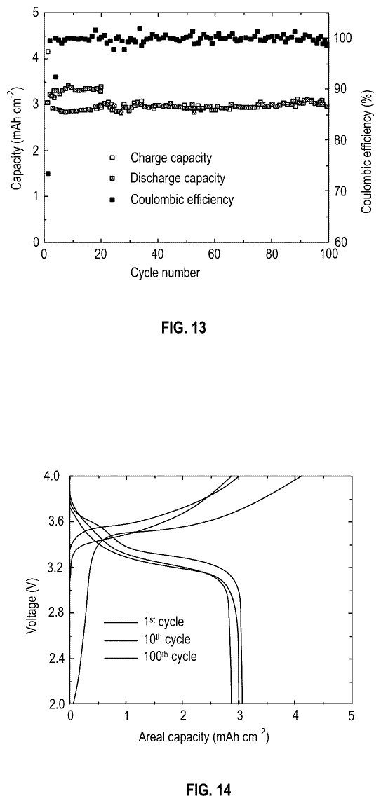

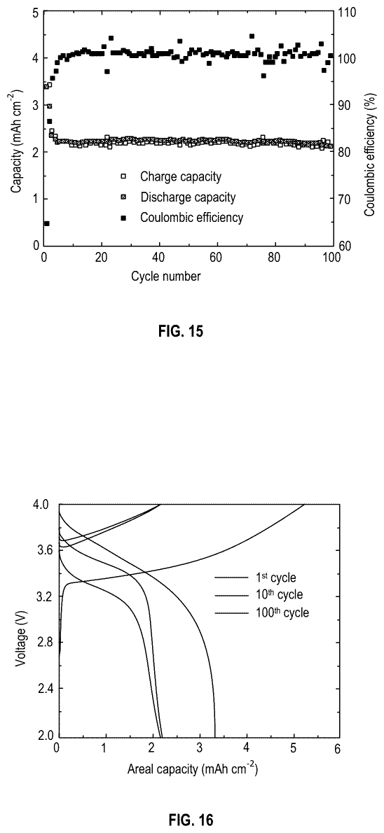

FIG. 13 shows galvanostatic data from solid-state battery cells with a prelithiated Al foil anode, a Li₆PS₅Cl solid-state electrolyte separator, and a LiNi_{0.6}Mn_{0.2}Co_{0.2}O₂ cathode. A current density of 0.2 mA cm⁻² was used for the first two cycles, and then it was increased to 1 mA cm⁻² for subsequent cycles. A stack pressure of 50 MPa was used. The cell with the prelithiated foil exhibits high capacity (˜3 mAh cm⁻²) and good stability over 100 cycles. FIG. 14 provides galvanostatic voltage curves on the first, tenth, and one-hundredth cycles of the cycling test in FIG. 13, showing that the initial Coulombic efficiency is 73.6%. FIG. 15 shows that the cell tested under the same conditions with a non-prelithiated Al foil features lower capacity (˜2.25 mAh cm⁻²) and an initial Coulombic efficiency of 64.8%. FIG. 16 provides galvanostatic voltage curves on the first, tenth, and one-hundredth cycles of the cycling test in FIG. 15. The prelithiation clearly increases the initial Coulombic efficiency and cycling capacity.

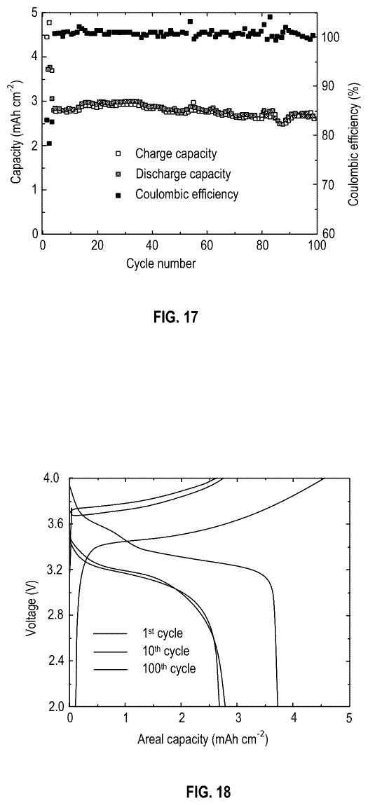

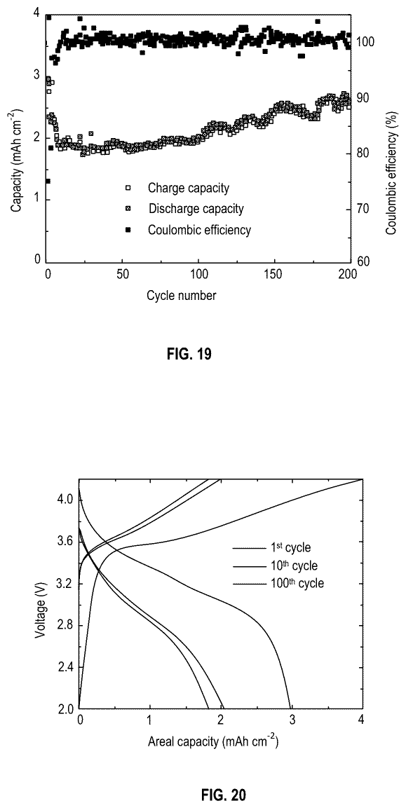

FIG. 17 shows galvanostatic data from solid-state battery cells with a prelithiated Al—Bi foil anode, a Li₆PS₅Cl solid-state electrolyte separator, and a LiNi_{0.6}Mn_{0.2}Co_{0.2}O₂ cathode. The cathode loading was 4.0 mAh cm⁻². A current density of 0.2 mA cm⁻² was used for the first two cycles, and then it was increased to 1 mA cm⁻² for subsequent cycles. A stack pressure of 50 MPa was used. The cell with the prelithiated Al—Bi foil exhibits high capacity (˜2.8 mAh cm⁻²) and good stability over 100 cycles. FIG. 18 provides galvanostatic voltage curves on the first, tenth, and one-hundredth cycles of the cycling test in FIG. 17, showing an initial Coulombic efficiency is 83.1%. FIG. 19 shows related data from full cell testing under the same conditions but with a prelithiated Al—Si foil electrode. The cell with the prelithiated Al—Si foil exhibits good stability over 200 cycles and slightly increasing capacity (1.8-2.5 mAh cm⁻²) with cycling. FIG. 20 provides galvanostatic voltage curves on the first, tenth, and one-hundredth cycles of the cycling test in FIG. 19, showing an initial Coulombic efficiency is 74.8%.

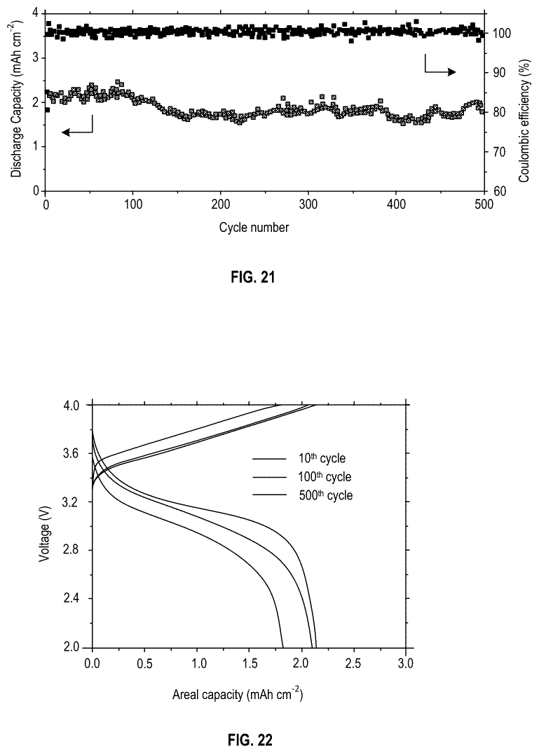

FIG. 21 shows galvanostatic data from solid-state battery cells with a prelithiated Al—In foil anode, a Li₆PS₅Cl solid-state electrolyte separator, and a LiNi_{0.6}Mn_{0.2}Co_{0.2}O₂ cathode. The cathode loading was 4.0 mAh cm⁻². A current density of 0.2 mA cm⁻² was used for the first two cycles, and then it was increased to 2 mA cm⁻² for subsequent cycles. A stack pressure of 50 MPa was used. The cell with the prelithiated Al—In foil exhibits good stability over 500 cycles and high capacity (˜2.0 mAh cm⁻²). The initial Coulombic efficiency is 85.3%. FIG. 22 provides galvanostatic voltage curves on the tenth, one-hundredth, and five-hundredth cycles of the cycling test of the cycling test in FIG. 21.

The prelithiation techniques disclosed herein can be used together with the methodologies from PCT Publication No. WO/2024186888 to enable improved performance at low stack pressure. Adding an ion-conducting interfacial layer helps maintain contact with the prelithiated anode and the solid-state electrolyte during charge-discharge cycling at low stack pressure.

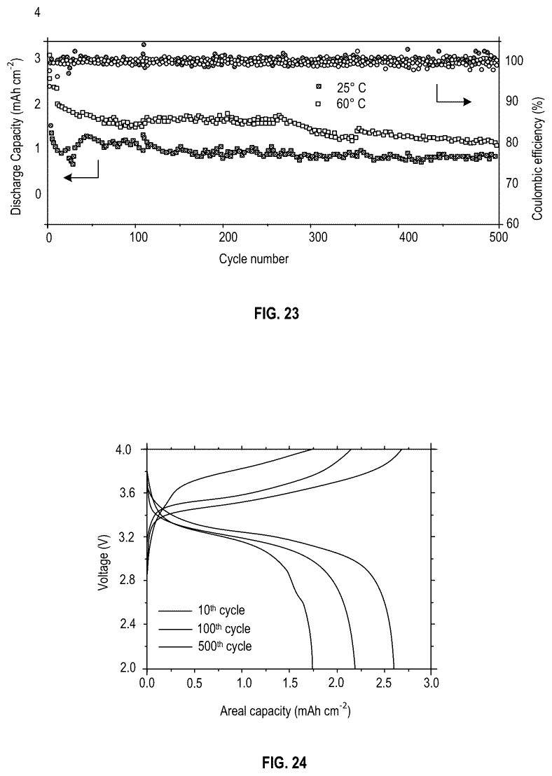

FIG. 23 shows galvanostatic data from solid-state battery cells with a prelithiated Al—In foil anode with In interfacial layer coating, a Li₆PS₅Cl solid-state electrolyte separator, and a LiNi_{0.6}Mn_{0.2}Co_{0.2}O₂ cathode. The cathode loading was 4.0 mAh cm⁻². A current density of 0.2 mA cm⁻² was used for the first two cycles, and then it was increased to 2 mA cm⁻² for subsequent cycles. A stack pressure of 5 MPa was used. The temperature is 25° C. or 60° C. The cell with the prelithiated Al—In foil with In interfacial layer exhibits good stability over 500 cycles and high capacity (˜2.2 mAh cm⁻² at 60° C. and ˜1.5 mAh cm⁻² at 25° C.). FIG. 24 provides galvanostatic voltage curves on the tenth, one-hundredth, and five-hundredth cycles of the cycling test of the cycling test at 60° C. in FIG. 23.

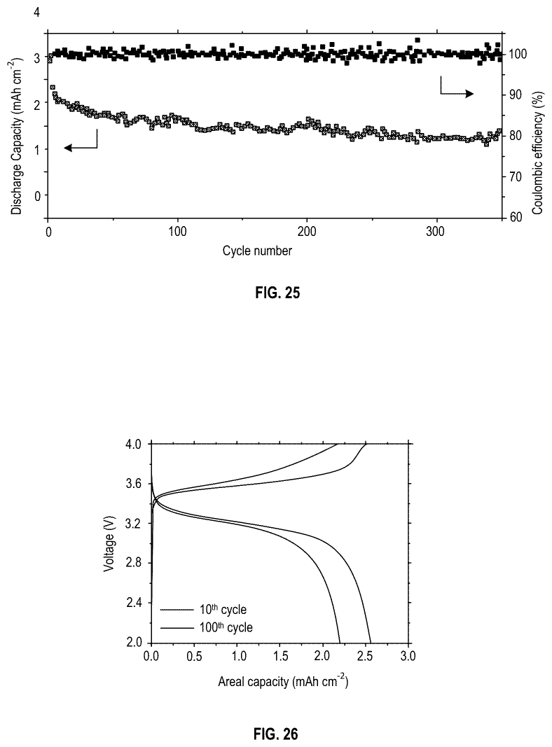

FIG. 25 shows galvanostatic data from solid-state battery cells with a prelithiated Al—In foil anode with In interfacial layer coating, a Li₆PS₅Cl solid-state electrolyte separator, and a LiNi_{0.6}Mn_{0.2}Co_{0.2}O₂ cathode. The cathode loading was 4.0 mAh cm⁻². A current density of 0.2 mA cm⁻² was used for the first two cycles, and then it was increased to 0.5 mA cm⁻² for subsequent cycles. A stack pressure of 2 MPa was used. The temperature is 25° C. The cell with the prelithiated Al—In foil with In interfacial layer exhibits good stability over 350 cycles and high capacity (˜2.0 mAh cm⁻²). FIG. 26 provides galvanostatic voltage curves on the tenth and one-hundredth cycles of the cycling test of the cycling test in FIG. 25.

Below, an exemplary method of making a solid-state battery with a prelithiated anode is disclosed.

### Anode Preparation

For the fabrication of multi-phase aluminum foils, stoichiometric amounts of aluminum and other elements were placed in a crucible and melted together, followed by natural cooling. The ingots were then rolled via an electric roller down to 30 μm. The aluminum foil samples with indium interfacial layer coating were prepared by immersing aluminum foils in an InCl₃ solution, during which a thin indium layer was deposited via a galvanic replacement reaction. For the roll-to-roll prelithiation, foil anodes and lithium foils were roll pressed together via an electric roller at 120° C.

### Cathode Preparation

The cathode was a composite mixture of LiNi_{0.6}Mn_{0.2}Co_{0.2}O₂ (NMC622) active material, Li₆PS₅Cl solid electrolyte (LPSC), and vapor grown carbon fiber (VGCF). LiNb_{0.5}Ta_{0.5}O₃ was coated on the active cathode material to prevent side reactions with the sulfide electrolyte. The composition of the cathode was 70 wt. % of coated NMC622, 27.5 wt. % LPSC, and 2.5 wt. % VGCF.

### Half Cell Assembly

The solid-state separator layer was fabricated by pressing Li₆PS₅Cl powders at 250 MPa inside the anvil cell. Then, the foil working electrode was added and pressed at 375 MPa. A lithium metal foil was added to the counter electrode side.

### Full Cell Assembly

The solid-state separator layer was fabricated by pressing Li₆PS₅Cl powders at 125 MPa inside the anvil cell. Then, cathode composite powders were added and pressed at 250 MPa. The foil anode was added to the opposite side of the cell before pressing the full cell to 375 MPa.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method comprising:
compressively rolling a first foil and a second foil together such that lithium in the second foil reacts with aluminum in the first foil; and
converting aluminum or aluminum alloy in a first phase of the first foil to a lithium-aluminum alloy to form a prelithiated anode material;
wherein:
the first foil comprises:
a first phase comprising aluminum or an aluminum alloy, wherein between 50-99 at % of a composite foil of the first foil and the second foil comprises the first phase; and
a second phase interspersed with the first phase, the second phase comprising a conductive element, wherein between 1-50 at % of the composite foil comprises the second phase; and
the second foil comprises lithium.

2. The method of claim 1, wherein the prelithiated anode material further comprises pristine aluminum comprising <5 at % lithium.

3. The method of claim 1, wherein the prelithiated anode material further comprises pristine indium comprising <5 at % lithium.

4. The method of claim 1, wherein the prelithiated anode material further comprises pristine bismuth comprising <5 at % lithium.

5. The method of claim 1 further comprising:
providing a cathode; and
positioning a solid-state electrolyte between the prelithiated anode material and the cathode;
wherein the method forms a solid-state battery.

6. The method of claim 1, wherein at least one of:
between 80-98 at % of the first foil comprises the first phase;
the second foil comprises a foil that is inert to reaction with lithium and the lithium forms a layer on the second foil that is inert to reaction with lithium; or
the compressively rolling occurs at a temperature of between 20-150° C.

7. The method of claim 1, wherein the compressively rolling occurs at a temperature of between 20-150° C.

8. The method of claim 1, wherein:
the first phase of the first foil comprises a lithium-aluminum alloy, wherein between 45-99 at % of the first phase comprises lithium; and
the second phase of the first foil comprises an alloy selected from a group consisting of a lithium-indium alloy and lithium-bismuth alloy interspersed with the first foil phase, wherein between 45-99 at % of the second phase comprises lithium.

9. The method of claim 1, wherein the lithium-aluminum alloy has a lithium-to-aluminum ratio of approximately 1:1.

10. The method of claim 5, wherein the solid-state battery exhibits an initial Coulombic efficiency of >80% and an average Coulombic efficiency above 99.5% for over 100 cycles.

11. The method of claim 5, wherein the solid-state battery exhibits an areal capacity of >2 mAh cm⁻² for over 100 cycles.

12. The method of claim 6, wherein the lithium layer has a thickness of between 0.1-50 microns.

13. The method of claim 6 further comprising depositing the lithium on the second foil that is inert to reaction with lithium;
wherein the lithium layer has a thickness of between 0.1-50 microns.

14. The method of claim 12, wherein the depositing comprises depositing using electrodeposition, thermal evaporation, rolling a lithium foil with the foil that is inert to reaction with lithium, or combinations thereof.

15. A method of making a solid-state battery comprising:
forming a prelithiated composite foil anode comprising:
compressively rolling a first foil and a second foil of the prelithiated composite foil anode together such that lithium in the second foil reacts with aluminum in the first foil;
wherein the first foil comprises:
a first foil phase comprising a lithium-aluminum alloy, wherein between 45-99 at % of the first foil phase comprises lithium; and
a second foil phase comprising an alloy selected from a group consisting of a lithium-indium alloy and lithium-bismuth alloy interspersed with the first foil phase, wherein between 45-99 at % of the second foil phase comprises lithium; and
wherein the second foil comprises lithium;
providing a cathode; and
positioning a solid-state electrolyte between the anode and the cathode.

16. The method of claim 15, wherein at least one of:
between 80-98 at % of the first foil comprises the first foil phase;
the second foil comprises a foil that is inert to reaction with lithium and the lithium forms a layer on the foil that is inert to reaction with lithium; or
the compressively rolling occurs at a temperature of between 20-150° C.

17. The method of claim 15, wherein at least one of:
the prelithiated composite foil anode further comprises pristine aluminum comprising <5 at % lithium;
the prelithiated composite foil anode further comprises pristine indium comprising <5 at % lithium; or
the prelithiated composite foil anode further comprises pristine bismuth comprising <5 at % lithium.

18. The method of claim 15, wherein:
between 50-99 at % of the prelithiated composite foil anode comprises the first foil phase; and
between 1-50 at % of the prelithiated composite foil anode comprises the second foil phase.

19. The method of claim 15, wherein at least one of:
the solid-state battery exhibits an initial Coulombic efficiency of >80% and an average Coulombic efficiency above 99.5% for over 100 cycles; or
the solid-state battery exhibits an areal capacity of >2 mAh cm⁻² for over 100 cycles; or
the lithium-aluminum alloy of the first phase has a lithium-to-aluminum ratio of approximately 1:1.

20. The method of claim 16, wherein the lithium layer has a thickness of between 0.1-50 microns.

21. The method of claim 16, wherein:
the forming the prelithiated composite foil anode further comprises depositing the lithium on the foil that is inert to reaction with lithium;
wherein the lithium layer has a thickness of between 0.1-50 microns.
